(19) United States
(12) Patent Application Publication
(10) Pub. No.: US 2012/0057443 A1
(43) Pub. Date: Mar. 8, 2012

(54) INFORMATION RECORDING APPARATUS, INFORMATION RECORDING METHOD, AND COMPUTER PROGRAM

(76) Inventor: Akira Shirota, Kawasaki (JP)

(21) Appl. No.: 13/318,825

(22) PCT Filed: May 18, 2009
(86) PCT No.: PCT/JP2009/059130

§ 371 Date: Nov. 4, 2011

(51) Int. Cl. G11B 7/00; G11B 7/1263

(52) U.S. Cl. 369/47.5; 369/121; G9B/7.001; G9B/7.1

(57) ABSTRACT

An information recording apparatus carries out DC writing on a section B to change a reflectivity from a recording surface to display a visible character or image. Next, the apparatus writes record data on each of sections A to C under a special recording condition. The special recording condition is a recording condition that: makes excellent the recording characteristics of each of the sections A to C after the record data has been recorded, and sets the pulse width of a write signal for writing a shortest mark to be shorter than an optimum pulse width.

### TECHNICAL FIELD OF THE INVENTION

The present invention relates to techniques for forming visible characters and/or figures on an information recording surface of an information recording medium, and recording information on the information recording surface.

### BACKGROUND ART

There is a conventional technique to irradiate laser beams onto a data recording surface of a recordable optical disc to form visible characters and/or images (for example, see Patent Documents 1, 2, and 3). This technique forms, on the data recording surface, areas respectively with different laser-beam reflectivities, which allows predetermined characters and/or images to be visible. For example, displaying information, such as a title, associated with recorded data as a visible image eliminates the need to write the information associated with the recorded data by hand, or to print the information, thus facilitating determination of optical discs.

### CITATION LIST

### Patent Document

Patent document 1: Japanese Patent Laid-Open No. H6-36514
Patent document 2: Japanese Patent Laid-Open No. 2004-39027
Patent document 3: Japanese Patent Laid-Open No. 2005-92935

### DISCLOSURE OF THE INVENTION

### Problems to be Solved by the Invention

A method of forming visible images set forth above will be described with reference to FIG. 1. FIG. 1 is a schematic view of an example of the method of forming visible images. For example, as illustrated in FIG. 1, for forming a visible image on a section B, performing DC (Direct Current) writing on the section B causes the reflectivity of the section B to be lower than the reflectivities of sections A and C as other unrecorded sections, thus forming a visible image on the section B. Note that, as illustrated in (a) of FIG. 17, the DC writing refers to the write mode to output a signal with constant write power.

Overwriting data to be recorded, referred to as “record data”, into an area, referred to as a “visible-image area”, on which a visible image has been formed may reduce recording characteristics. For this reason, a visible-image area is normally formed on a part of a data recording surface, and record data is written into a unrecorded area on which no visible-image areas have been formed. FIG. 2 is a schematic view of an example of the method of recording, on an optical disk in which a visible-image area has been formed, record data. For example, as illustrated in FIG. 2, if the section B has been established as a visible-image area, record data is written into each of the sections A and C as unrecorded sections.

As described above, in the art, because no record data is recorded on visible-image areas, an optical disc in which a visible-image area has been formed may have a storage capacity for record data lower than a storage capacity for record data of another optical disc in which no visible-image areas have been formed. It is desirable therefore to provide a technology that enables overwriting record data on a visible-image area without reducing recording characteristics.

In addition, for recording record data an area other than visible-image areas, it is necessary to identify boundaries between visible-image areas and unrecorded areas. For this reason, it is also desirable to provide a technology that enables record data to be recorded without regard to the boundaries between visible-image areas and unrecorded areas.

The present invention has been made in view of the aforementioned circumstances, and has an example of a purpose of providing information recording apparatuses, information recording methods, and computer programs, which are capable of recording record data over a recording surface including a visible-image area under a same condition, and improving recording characteristics of an area on which the record data has been recorded.

### Means for Solving the Problems

In order to achieve such a purpose provided above, a first aspect of the present invention is an information recording apparatus for irradiating a laser beam on an information recording surface of an information storage medium to record information, the information recording apparatus. The information recording apparatus includes a visible-image forming means that irradiates a laser beam on the information recording surface under a first recording condition to form a visible character or a visible image on the information recording surface, and a record-data recording means that irradiates a laser beam on the information recording surface under a second recording condition to write record data on the information recording surface. A first area on which the laser beam is irradiated by the visible-image forming means under the first recording condition and a second area on which the laser beam is irradiated by the record-data recording means under the second recording condition are at least partly overlapped with each other.

A second aspect of the present invention is an information recording method of irradiating a laser beam on an information recording surface of an information storage medium to record information. The information recording method includes a visible-image forming step that irradiates a laser beam on a first area of the information recording surface under a first recording condition to form a visible character or a visible image on the first area, and a record-data recording step that irradiates, after execution of the visible-image forming step, a laser beam on a second area of the information recording surface under a second recording condition to write record data on the second area, the second area including the first area. The second recording condition is to set a pulse width of a write signal for writing a predetermined mark to be recorded to be shorter than an optimum pulse width of the write signal for writing the predetermined mark.

A third aspect of the present invention is an information recording method of irradiating a laser beam on an information recording surface of an information storage medium to record information. The information recording method includes a record-data recording step that irradiates a laser beam on a third area of the information recording surface under a third recording condition to write record data on the third area, and a visible-image forming step that irradiates, after execution of the record-data recording step, a laser beam on at least part of the third area under a fourth recording condition to change a reflectivity from the information recording surface, thus forming a visible character or a visible picture on the at least part of the third area. The third recording condition is to set a pulse width of a write signal for writing a predetermined mark to be recorded to be longer than an optimum pulse width of the write signal for writing the predetermined mark.

A fourth aspect of the present invention is a computer program that functions a computer as each means of the information recording apparatus according to the first aspect of the present invention.

### BRIEF DESCRIPTION OF THE DRAWINGS

FIG. 1 is a schematic view of an example of conventional visible-image forming methods;

FIG. 2 is a schematic view of an example of methods of recording, on an optical disk in which a visible-image area has been formed, record data;

FIG. 3 is a schematic view of an example of a data recording method according to an embodiment of the present invention;

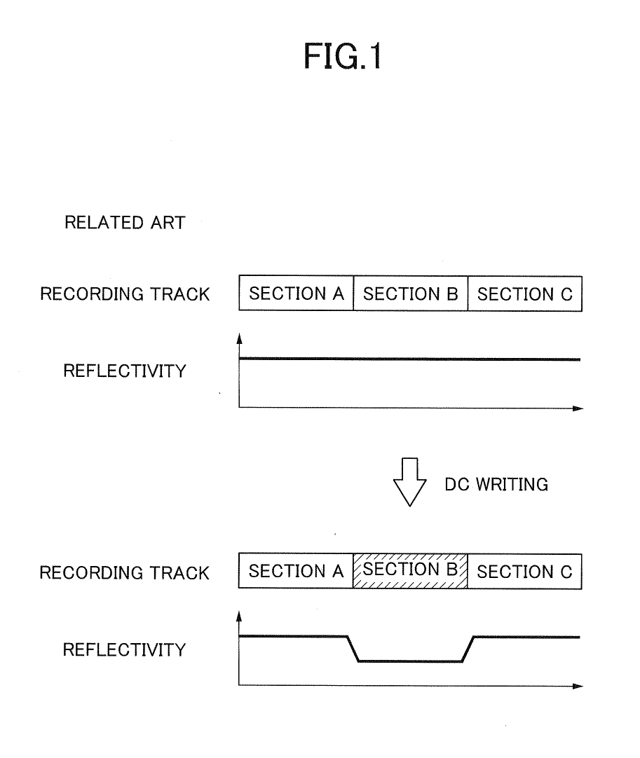

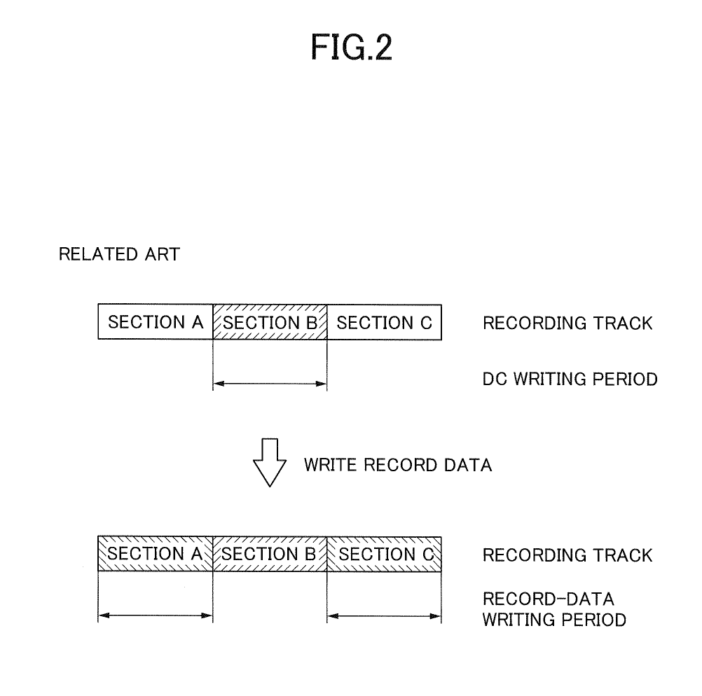

(a) of FIG. 4 is a view illustrating an example of the waveform of a write signal in a normal recording condition, and (b) of FIG. 4 is a view illustrating an example of the waveform of a write signal in a special recording condition;

(a) of FIG. 5 is a graph illustrating the relationship between each level of write power for forming a corresponding visible image and a corresponding value of jitter in a corresponding formed visible-image area in which record data has been recorded in the normal recording condition, and (b) of FIG. 5 is a graph illustrating the relationship between each level of write power for forming a corresponding visible image and a corresponding value of reflectivity in a corresponding formed visible-image area in which record data has been recorded in the normal recording condition;

(a) of FIG. 6 is a graph illustrating the relationship between each level of write power for forming a corresponding visible image and a corresponding value of jitter in a corresponding formed visible-image area in which record data has been recorded in the special recording condition, and (b) of FIG. 6 is a graph illustrating the relationship between each level of write power for forming a corresponding visible image and a corresponding value of reflectivity in a corresponding formed visible-image area in which record data has been recorded in the special recording condition;

(a) of FIG. 7 is a graph illustrating the relationship between values of PI error in a formed visible-image area in which record data has been recorded and corresponding distances from the center of an optical disc, and (b) of FIG. 7 is a visible image formed in the optical disc;

FIG. 8 is a schematic structural view of an information recording apparatus according to the embodiment of the present invention;

FIG. 9 illustrates an example of DC write-power information stored in a memory of the information recording apparatus according to the embodiment of the present invention;

FIG. 10 illustrates another example of the DC write-power information stored in the memory of the information recording apparatus according to the embodiment of the present invention;

FIG. 11 is a schematic view illustrating an example of a method of forming a visible image using a plurality of levels of DC write power;

FIG. 12 illustrates an example of special strategy information stored in the memory of the information recording apparatus according to the embodiment of the present invention;

FIG. 13 illustrates another example of special strategy information stored in the memory of the information recording apparatus according to the embodiment of the present invention;

FIG. 14 is a flowchart illustrating operations of the data recording method of the information recording apparatus according to the embodiment of the present invention;

FIG. 15 is a flowchart representing in detail a visible-image forming process in step S100 of FIG. 14;

FIG. 16 is a flowchart representing in detail a record-data recording process in step S200 of FIG. 14;

FIG. 17 is a view illustrating various waveforms of write signals for forming visible images according to the embodiment of the present invention;

(a) of FIG. 18 illustrates an example of the waveform of a square-wave write signal when controlling power of the square-wave write signal forms visible images according to the embodiment of the present invention;

(b) of FIG. 18 illustrates an example of the waveform of a square-wave write signal when controlling pulse widths of the square-wave write signal form visible images according to the embodiment of the present invention;

FIG. 19 is a schematic view of a data recording method according to a modification of the embodiment of the present invention;

FIG. 20 is a flowchart representing operations of a data recording method according to another modification of the embodiment of the present invention;

FIG. 21 illustrates an example of DC write-power information stored in the memory of the information recording apparatus according to an alternative embodiment of the present invention; and

FIG. 22 illustrates an example of special strategy information stored in the memory of the information recording apparatus according to the alternative embodiment of the present invention.

### EMBODIMENTS FOR CARRYING OUT THE INVENTION

An embodiment of the present invention will be described hereinafter with reference to the drawings.

<Data Recording Method>

A data recording method according to this embodiment of the present invention will be outlined. The data recording method according to this embodiment is a method of, after the form of a visible image on a data recording surface of an optical disc as an information recording medium using the DC writing, recording record data on a given area including a visible-image area in the data recording surface under the same recording condition; the same recording condition will be referred to as a “special recording condition”. Note that “record data” according to this embodiment means data without including data, such as display data, for forming visible images.

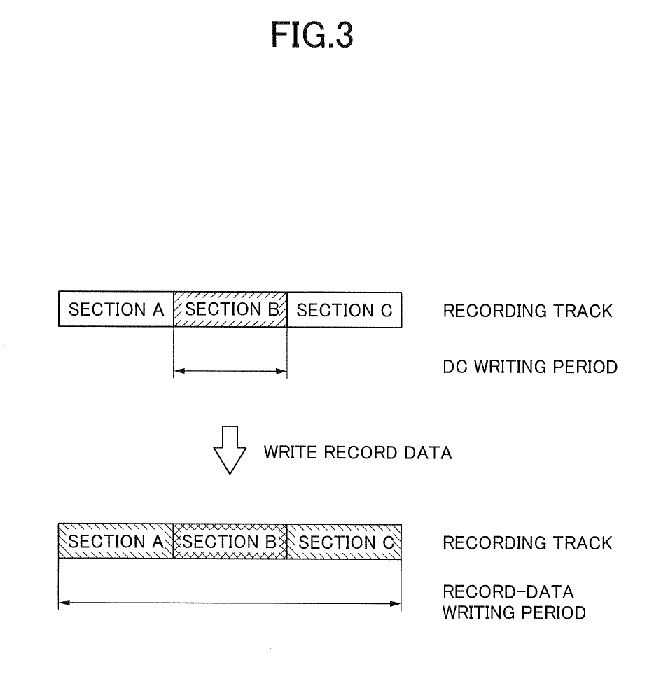

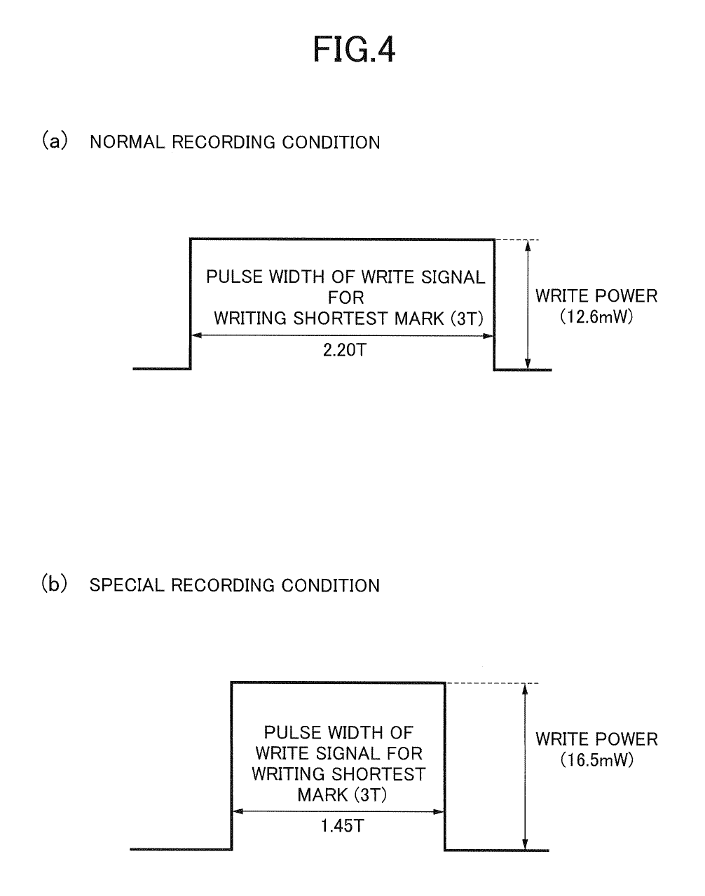

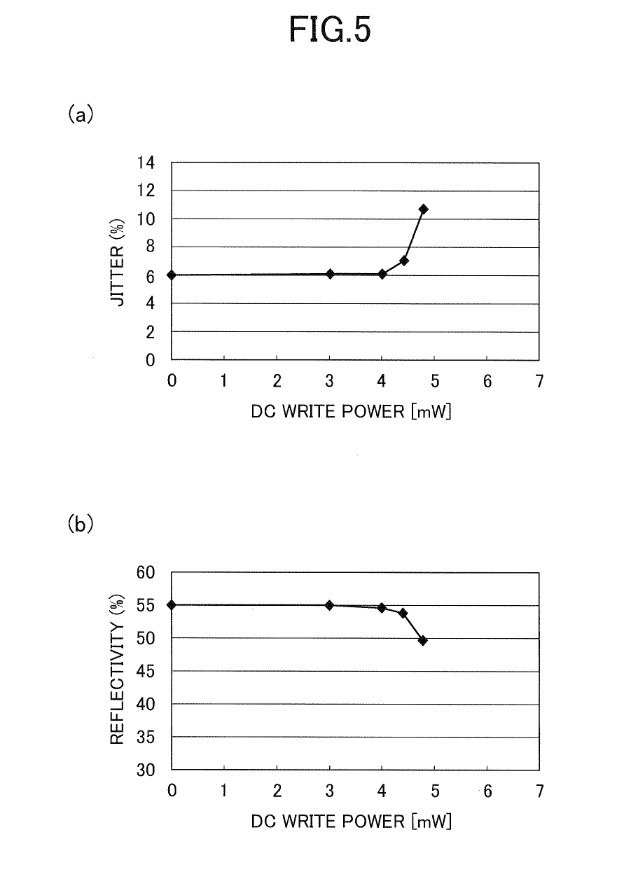

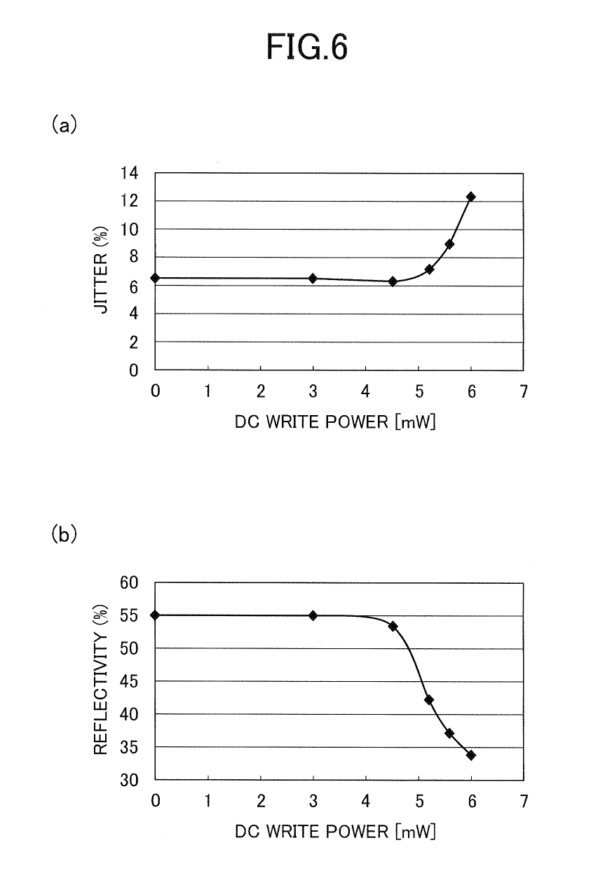

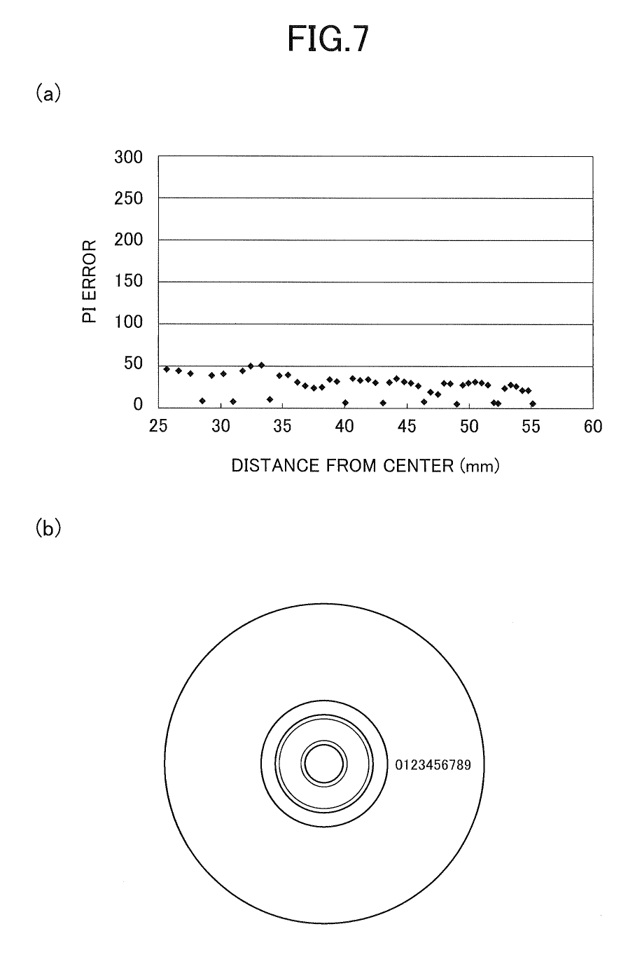

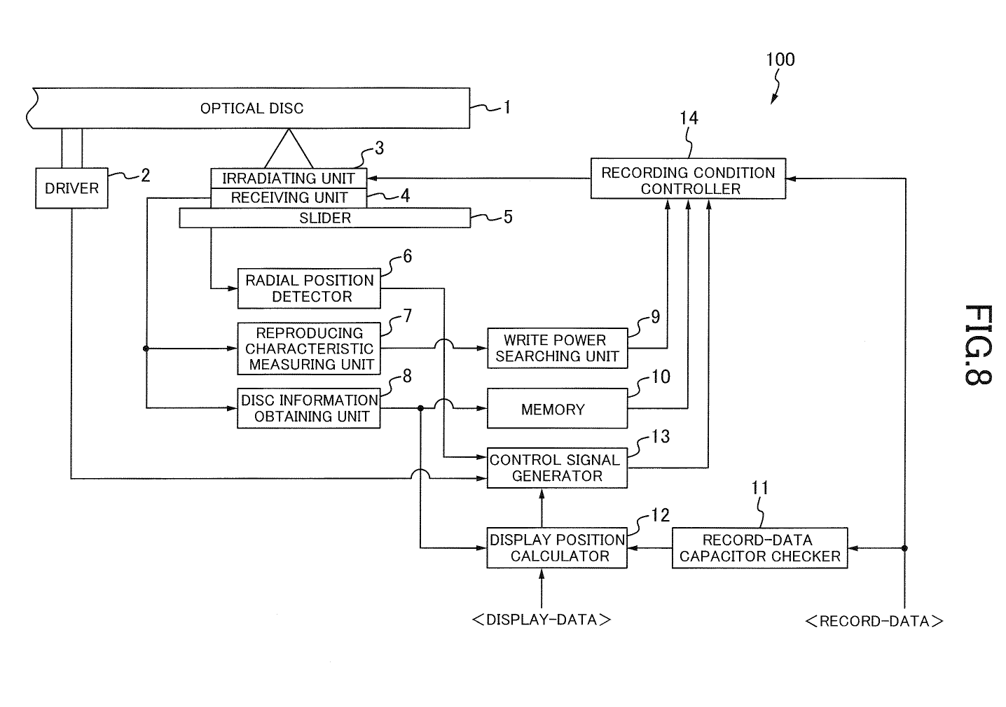

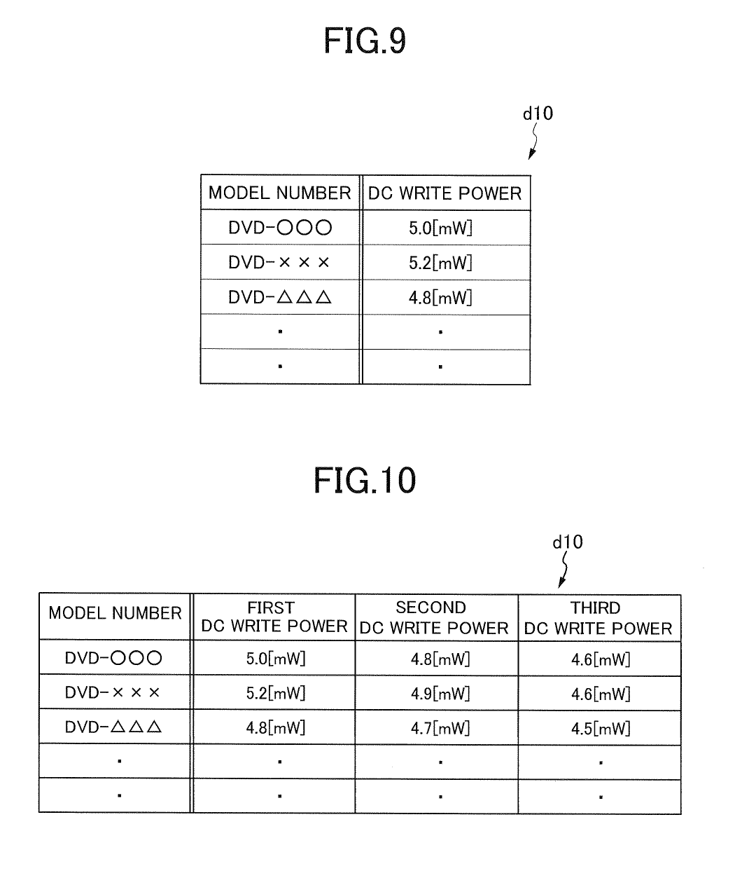

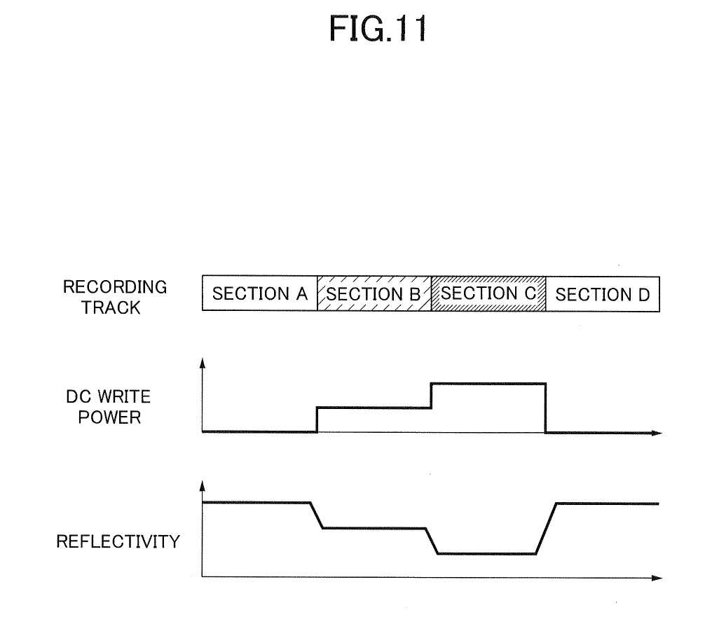

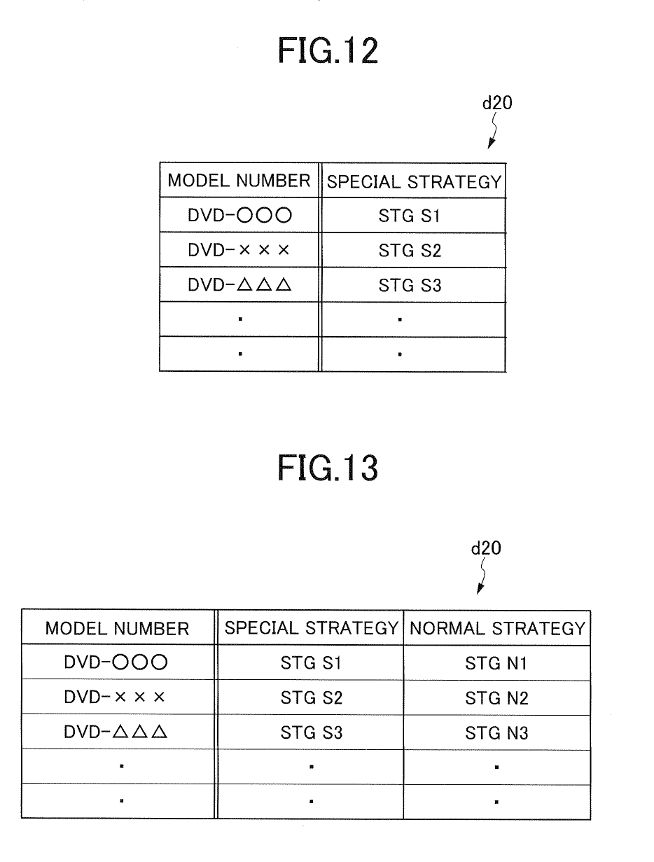

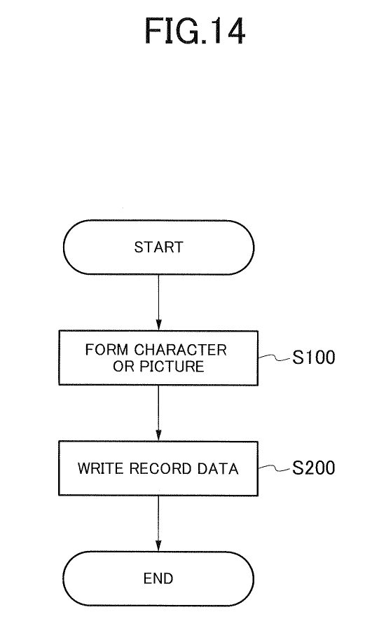

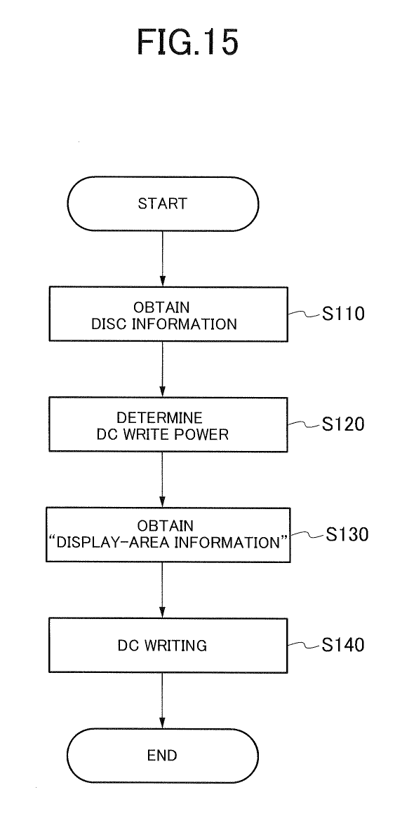

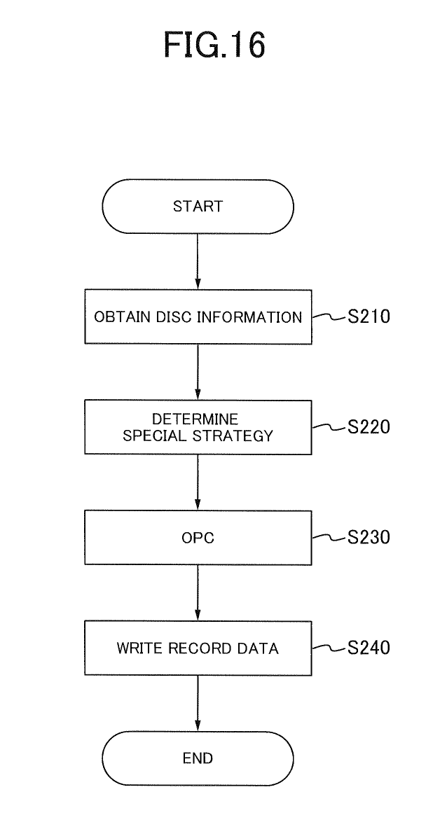

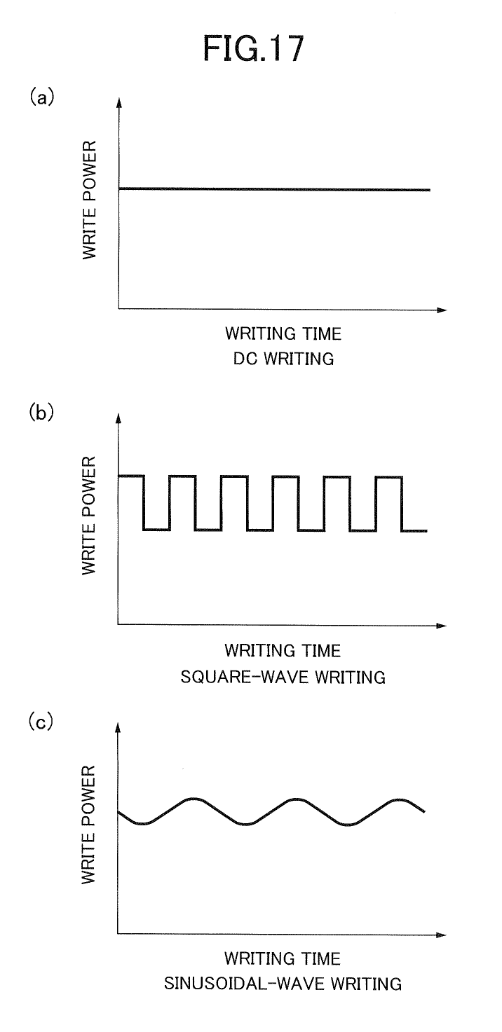

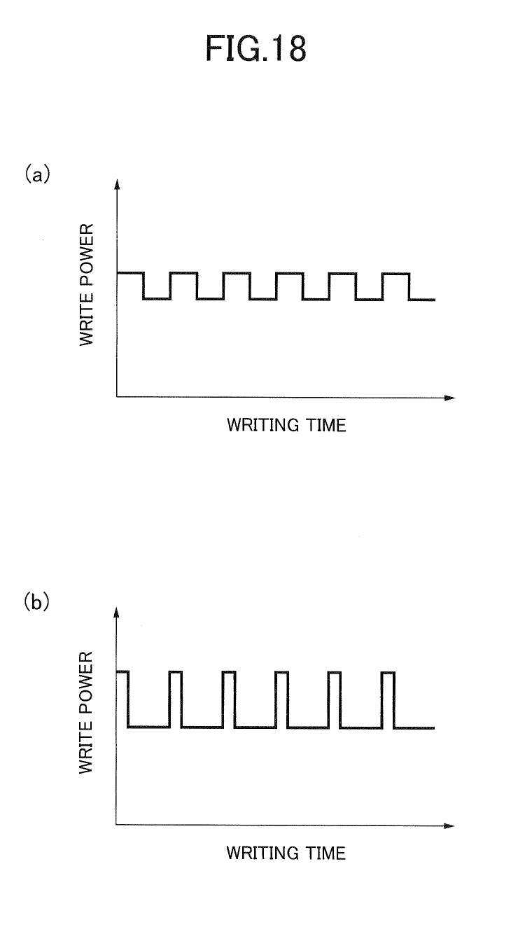

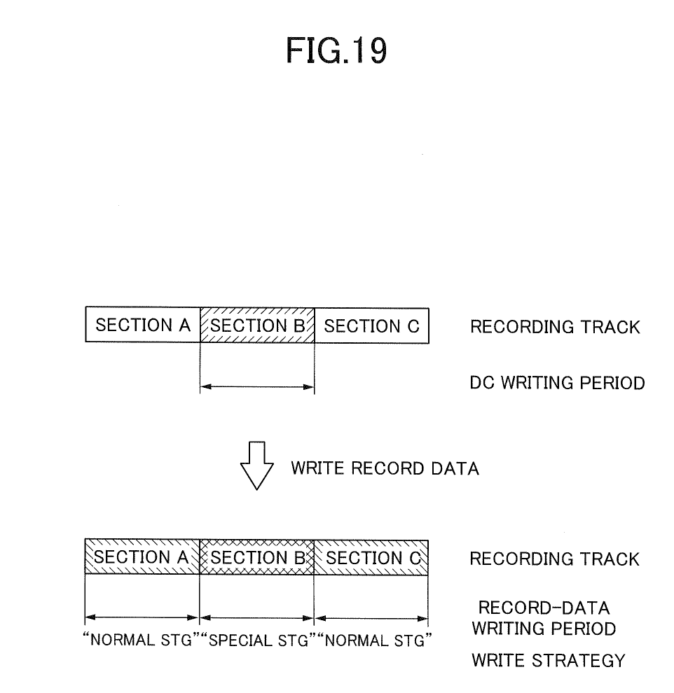

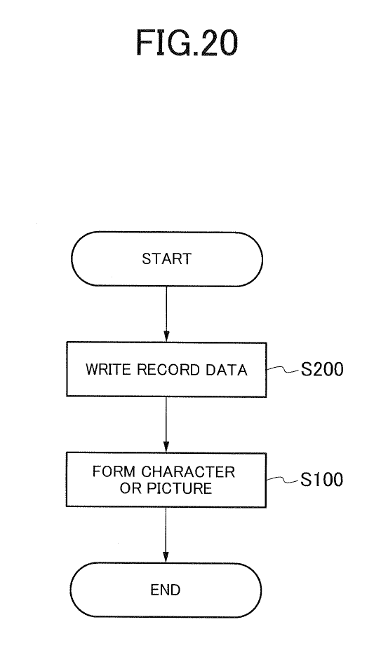

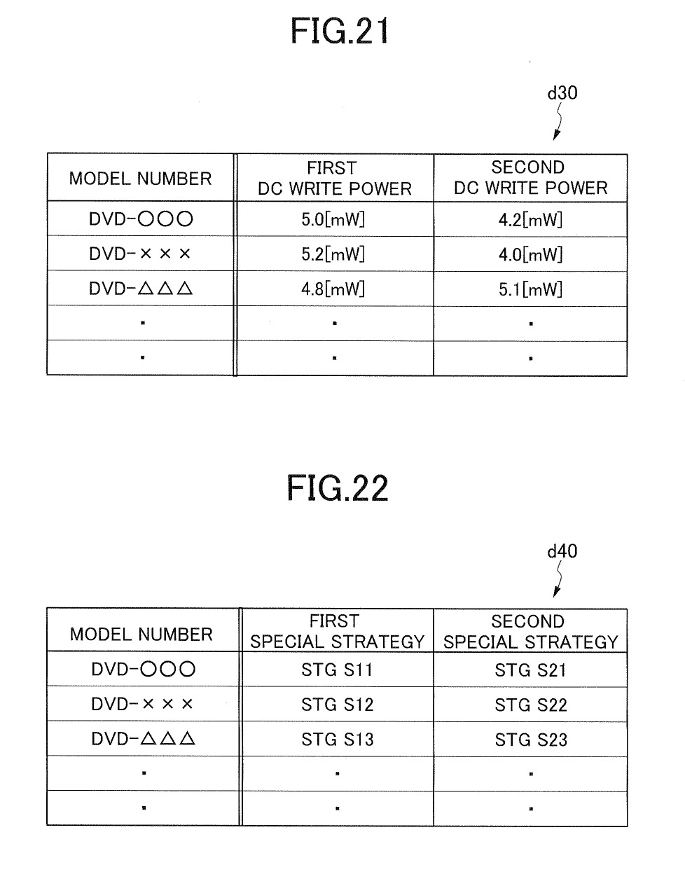

This will be specifically described with reference to FIG. 3. FIG. 3 is a schematic view of an example of the data recording method according to this embodiment. For example, as illustrated in FIG. 3, if the DC writing is carried out for a section B so that the section B is established as a visible-image area, the data recording method is to write record data into all of the sections A to C under the same recording condition (special recording condition). The special recording condition, which will be described in detail later, is a recording condition that allows recording characteristics of each of the sections A to C to get better.

The data recording method according to this embodiment permits overwriting of record data in a visible-image area, thus preventing the reduction of the storage capacity of an optical disc even if a visible image has been formed in a data recording surface of the optical disc. The data recording method according to this embodiment also can write record data over a data recording surface under the same recording condition (the special recording condition) without regard to visible-image areas. This can eliminate the need of special control around each of the boundaries.

Note that recordable optical discs to be used in this embodiment are normal discs including available recordable optical discs, such as CD-R/RW, DVD±R/RW, and BD-R/RE.

<Experiment Data>

Next, the data recording method according to this embodiment will be described using specific experiment data. Note that this experiment was carried out by: forming a visible-image area in an available DVD-R using the DC writing, overwriting record data on the formed visible-image area, and measuring the recording characteristics of the visible-image area on which the record data has been recorded. Note that the DC writing was carried out at 1× write speed, and the writing of the record data was carried out at 2× write speed.

In the write of record data, two recording conditions were used, one of which is a normal recording condition using a normal strategy, the other of which is a special recording condition using a special strategy.

The normal strategy is a write strategy that adjusts, relative to an optimum pulse width, specifically, 2.20 T, of a write signal for writing a shortest mark to be recorded, pulse widths of write signals for writing other marks (4 T to 14 T) to be recorded in order to make better recording characteristics. Hereinafter, write power in the normal recording condition will be referred to as “normal power”, and the write strategy in the normal recording condition will be referred to as a “normal strategy”. (a) of FIG. 4 illustrates, in the normal recoding condition, the waveform of a write signal for writing the shortest mark (3 T) to be recorded. The write strategy, which is the pulse width of a write signal for writing the shortest mark, is set to 2.20 T, and the write power, which is write power of the write signal for writing the shortest mark is set to 12.6 mW.

Note that the optimum pulse width means a pulse width that allows recording characteristics, which are obtained by writing record data on an unrecorded area using the pulse width, to be optimized; the unrecorded area is an area of a data recording surface on which no visible images are formed and no record data are recorded. In this embodiment, the write strategy means the pulse width of a write signal, and control of the write strategy means adjustment of the pulse width of a write signal.

The special strategy is a write strategy that adjusts, relative to a pulse width (specifically, 1.45 T), pulse widths of write signals for writing other marks (4 T to 14 T) in order to make better recording characteristics; the pulse width is lower than the optimum pulse width (specifically, 2.20 T) of a write signal for writing the shortest mark. Hereinafter, write power in the special recording condition will be referred to as “special power”, and the write strategy in the special recording condition will be referred to as a “special strategy”. (b) of FIG. 4 illustrates, in the special recoding condition, the waveform of a write signal for writing the shortest mark (3 T). The write strategy, which is the pulse width of a write signal for writing the shortest mark, is set to 1.45 T, and the write power, which is write power of the write signal for writing the shortest mark is set to 16.5 mW. Note that, in the special recording condition, the pulse widths of write signals for writing other marks 4 T to 14 T are shorter than optimum pulse widths.

FIG. 5 illustrates the results of experiments when record data is recorded in the normal recording condition, and FIG. 6 illustrates the results of experiments when record data is recorded in the special recording condition. (a) of each of FIGS. 5 and 6 is a graph illustrating the relationship between each level of write power of the DC writing for forming a corresponding visible image, which will be referred to as “DC write power”, and a corresponding value of jitter in a corresponding formed visible-image area in which record data has been recorded. (b) of each of FIGS. 5 and 6 is a graph illustrating the relationship between each level of DC write power for forming a corresponding visible image and a corresponding value of reflectivity in a corresponding formed visible-image area in which record data has been recorded.

Note that jitter represents the quality of recording characteristics, and therefore, the lower a jitter value is, the higher the quality of recording characteristics is. Specifically, the recording characteristics are good as long as a jitter value is equal to or lower than 8 percent. If a jitter value is equal to or higher than 10 percent, the recording characteristics deteriorate so that regeneration of corresponding record data may be disabled.

Let us consider the results of the experiments when record data is recorded when no DC writing is carried out with reference to FIGS. 5 and 6. In each of the graphs illustrated in FIGS. 5 and 6, a value of jitter and a value of reflectivity at the DC write power of 0 (mW) represent a value of the jitter and a value of the reflectivity when no DC writing is carried out, in other words, record data is recorded without visible images being formed.

In the normal recording condition, the jitter value in an area on which record data has been recorded when no DC writing is carried out is 6.0 percent, which shows that the recording characteristics are excellent. In the special recording condition, the jitter value in an area on which record data has been recorded when no DC writing is carried out is 6.6 percent, which shows that the recording characteristics are excellent. Specifically, each of the normal recording condition and the special recording condition allow the recording characteristics of a corresponding area on which record data has been recorded to be excellent. Note that, in the normal recording condition, the reflectivity of an area on which record data has been recorded when no DC writing is carried out is 54.9 percent, and, in the special recording condition, the reflectivity of an area on which record data has been recorded when no DC writing is carried out is 55.1 percent.

Next, let us consider the results of the experiments when record data is recorded after DC writing has been carried out with reference to FIGS. 5 and 6.

In the normal recording condition, as illustrated in (a) of FIG. 5, when the DC power rises to be close to a value, specifically, 4 mW, the jitter gradually rises, and thereafter, the jitter rises with reduction in the recording characteristics. In addition, as illustrated in (b) of FIG. 5, when the DC power rises to be close to a value, specifically, 4 mW, the reflectivity gradually drops, and thereafter, the reflectivity drops so that the difference between the reflectivity of the visible-image area and the reflectivity of another area, specifically, on which record data has been only recorded gradually increases. As described above, in the normal recording condition, there is a trade-off between the jitter and the reflectivity. When the DC write power rises, the variation in the reflectivity increases so that a visible image becomes recognizable with the recording characteristics deteriorating. Thus, it is difficult to keep the recording characteristics excellent with visible-image area being formed.

For example, if record data is recorded in the normal recording condition, as illustrated in (a) of FIG. 5, the DC write power must be equal to or lower than 4.5 mW in order to maintain excellent recording characteristics, that is, maintain the jitter equal to or lower than 8 percent. If the DC write power is equal to or lower than 4.5 mW, as illustrated in (b) of FIG. 5, the reflectivity of the visible-image area is lied within the range from 53.2 percent to 54.9 percent. Thus, the rate of variation of the reflectivity relative to the reflectivity of another area on which no DC writing is carried out is set to be substantially 3 percent, which is equal to: (54.9−53.2)/54.9.

If the jitter is allowed to vary up to 10 percent to thereby preferentially maintain the variation in the reflectivity, the DC write power must be equal to or lower than 4.7 mW. If the DC write power is equal to or lower than 4.7 mW, the reflectivity of the visible-image area is lied within the range from 50.5 percent to 54.9 percent. Thus, the rate of variation of the reflectivity relative to the reflectivity of another area on which no DC writing is carried out is set to be substantially 8 percent, which is equal to: (54.9−50.5)/54.9.

The variation range of the reflectivity is allowed to have no more than the order of 8 percent for recording record data in the normal recording condition. This is because, if the variation range of the reflectivity were set to be higher than the order of 8 percent, the jitter would more deteriorate to cause a risk of record data being non-regenerated.

Thermal interference between recorded marks may cause the recording characteristics to deteriorate. For example, in order to write record data into a DVD-R, irradiating a laser beam onto a dye-based recording layer causes a dye to be thermally decomposed so that recorded marks are formed. However, laser-beam irradiation for forming a recorded mark may affect on adjacent recorded marks, resulting in deterioration of the recording characteristics. The DC writing carried out according to this embodiment may increase the affect. The higher the DC write power is, the more increased the affect is. This may increase deterioration of the recording characteristics due to thermal interference.

Thus, in order to prevent deterioration of the recording characteristics due to thermal interference, the special strategy in the special recording condition sets laser-beam irradiation time for forming a mark to be shorter than laser-beam irradiation time of the normal strategy for forming a mark.

Specifically, as illustrated in (b) of FIG. 4, the pulse width of a write signal for writing a shortest mark (3 T) is set to be 1.45 T shorter than 2.20 T. This sets the pulse width of a write signal for writing a shortest mark (3 T) to be substantially a half of the length of time of the shortest mark; the length of time of the shortest mark is a triple of a clock cycle. This results in reduction of laser-beam irradiation time for forming a mark to thereby increase time during which no laser beam is irradiated, making it possible to prevent deterioration of the recording characteristics due to thermal interference.

In the special recording condition, as illustrated in (a) of FIG. 6, when the DC power rises to be close to a value, specifically, 4.5 mW, the jitter gradually rises, and thereafter, the jitter rises with reduction in the recording characteristics. In addition, as illustrated in (b) of FIG. 6, when the DC power rises to be close to a value, specifically, 4.0 mW, the reflectivity gradually drops, and thereafter, the reflectivity drops so that the difference between the reflectivity of the visible-image area and the reflectivity of another area, specifically, on which record data has been only recorded gradually increases. As well as the normal recording condition, in the special recording condition, the jitter changes depending on change in the reflectivity so that there is a trade-off between the jitter and the reflectivity. When the DC write power rises, the variation in the reflectivity increases so that a visible image becomes recognizable with the recording characteristics deteriorating. However, the graph illustrated in (a) of FIG. 6 demonstrates that, in comparison to the graph illustrated in (a) of FIG. 5, the jitter more gradually increases irrespective of increase in the DC write power. Thus, special recording condition makes it possible to obtain the variation in the reflectivity.

For example, if record data is recorded in the special recording condition, as illustrated in (a) of FIG. 6, the DC write power must be equal to or lower than 5.5 mW in order to maintain excellent recording characteristics, that is, maintain the jitter equal to or lower than 8 percent. If the DC write power is equal to or lower than 5.5 mW, as illustrated in (b) of FIG. 6, the reflectivity of the visible-image area is lied within the range from 39.0 percent to 55.1 percent. Thus, the rate of variation of the reflectivity relative to the reflectivity of another area on which no DC writing is carried out is set to be substantially 29 percent, which is equal to: (55.1−39.0)/55.1.

If the jitter is allowed to vary up to 10 percent to thereby preferentially maintain the variation in the reflectivity, the DC write power must be equal to or lower than 5.8 mW. If the DC write power is equal to or lower than 5.8 mW, the reflectivity of the visible-image area is lied within the range from 36.2 percent to 55.1 percent. Thus, the rate of variation of the reflectivity relative to the reflectivity of another area on which no DC writing is carried out is set to be substantially 34 percent, which is equal to: (55.1−36.2)/55.1.

The variation range of the reflectivity is allowed to have no more than the order of 34 percent for recording record data in the special recording condition. This prevents deterioration of the jitter while maintaining wide the variation range of the reflectivity. As described above, even if a visible image is formed on a data recording surface of an optical disc, the special recording condition provides good recording characteristics of a visible-image area on which record data has been recorded.

Note that, if record data is recorded in the special recording condition, the jitter corresponding to a value of the DC write power at which the variation of the reflectivity starts, that is, 4.5 mW or thereabout takes 6.3 percent. This value 6.3 percent of the jitter is lower than a corresponding value of the jitter, such as 6.6 percent if no DC writing is carried out. Specifically, if record data is recorded in the special recording condition, performing DC writing with the value of the DC write power at which the variation of the reflectivity starts allows recording characteristics to get better in comparison to recording characteristics with no DC writing.

Note that the experiments set forth above measured the jitter as a value indicative of the quality of recording characteristics, but can measure PI error as a value indicative of the quality of recording characteristics.

(a) of FIG. 7 illustrates a graph of the measured PI error. (a) of FIG. 7 demonstrates the result of an experiment in which record data was recorded over a recording surface including a visible-image area in the special recording condition. As illustrated in (b) of FIG. 7, DC writing was carried out in one radial direction of the data recording surface of an optical disc so that a visible image, specifically, the character of 01234567, was formed. Thereafter, data was recorded over the recording surface including the visible-image area. After the recording, values of the PI error were measured over the entire of the recording surface. (b) of FIG. 7 demonstrates the relationship between each value of the PI error and a corresponding distance from the center of the optical disc.

Note that the DC writing was carried out at 1× write speed, and the writing of the record data was carried out at 2× write speed. The DC write power was 5.7 mW, the special power in the special condition was 16.8 mW, the special strategy in the special condition was 1.45 T, which is a pulse width of a write signal for writing the shortest mark.

Normally, if a value of the PI error were equal to or greater than 280, the corresponding recording characteristics would deteriorate so that the record data would not be regenerated. However, the result of the experiment set forth above demonstrates that value of the PI error are limited to be equal to or lower than substantially 50, which shows that the visible-image area has good recoding characteristics.

<Structure of Information Recording Apparatus>

The structure of an information recording apparatus 100 that forms invisible images using the data recording method set forth above, and records record data will be described hereinafter.

FIG. 8 is a schematic structural view of the information recording apparatus 100 according to this embodiment of the present invention.

The information recording apparatus 100 can be designed as a computer equipped with a DVD (Digital Versatile Disk) recorder or a DVD drive. The information recording apparatus 100 records information on an optical disc 1. Each component described hereinafter can be controlled by a system controller (not shown).

A driver 2 is operative to control the rotation of the optical disc 1, and send, to a control-signal generator 13, reference-angle information.

An irradiating unit 3 consists mainly of an LD (Laser Diode; semiconductor laser), and is adapted to irradiate a laser beam to the optical disc 1 to thereby carry out recording and playback of information on the optical disc 1.

A receiving unit 4 consists mainly of a photo diode (PD), and is configured to receive light reflected from the optical disc 1 based on the irradiated laser beam.

A slider 5 is adapted to move, in a radial direction of the optical disc 1, a pickup head unit (PUH) consisting mainly of the irradiating unit 3 and the receiving unit 4.

A radial position detector 6 is adapted to detect a radial position of the PUH, and to send, to the control-signal generator 13, information indicative of the radial position of the PUH.

A reproducing characteristic measuring unit 7 is adapted to measure reproducing characteristics (recording characteristics) of a portion recorded at OPC (Optimum Power Control), and send, to a write-power searching unit 9, a result of the measurement.

A disc information obtaining unit 8 is adapted to obtain disc information previously stored in the optical disc 1; this disc information of the optical disc 1 includes its manufacture, its model number, its write strategy, and the like. The disc information obtaining unit 8 is also adapted to send, to a memory 10, the obtained information, and adapted to send, to a display position calculator 12, recording start position of record data.

The write power searching unit 9 is configured to select a write power level based on a variation of a write power level for the OPC and the reproducing characteristics sent from the reproducing characteristic measuring unit 7; the write power level for the OPC stepwisely varies for determining an optimum write power level. The selected write power level allows the reproducing characteristics to be most improved.

The write power searching unit 9 is also configured to send, to a recording condition controller 14, information associated with the optimum write power level.

The memory 10 stores therein information (DC write-power information) d10 associated with DC write power for forming visible images, and information (special strategy information) d20 for writing record data. The memory 10 is operative to determine, based on the disc information sent from the disc information obtaining unit 8, an optimum item of the DC write-power information d10 and an optimum item of the special strategy information d20, and send, to the recording condition controller 14, the determined optimum item of the DC write-power information d10 and the determined optimum item of the special strategy information d20.

FIG. 9 illustrates an example of the DC write-power information d10. Referring to FIG. 9, the DC write-power information is information that associates information (model number) of each disc with corresponding DC write power. That is, for each disc information (model number), a corresponding optimum level of DC write power is stored in the DC write-power information d10. For example, when the model number of the optical disc 1 is “DVD-◯◯◯”, the corresponding DC write power is 5.0 mW, and the DC write power of 5.0 mW is sent to the recording condition controller 14 as the determined DC write-power information d10.

Note that the structure of the DC write-power information d10 is not limited to the data structure illustrated in FIG. 9. As another example, FIG. 10 illustrates DC write-power information d10 including a plurality of levels of DC write power. The DC write-power information d10 illustrated in FIG. 10 is information that associates information (model number) of each disc with a corresponding set of levels of DC write power. That is, for each disc information (model number), a corresponding set of optimum levels of DC write power is stored in the DC write-power information d10. In order to produce gray-scale visible images of, for example, pictures, it is necessary to change the reflectivity of the visible-image area. For example, when the model number of the optical disc 1 is “DVD-◯◯◯”, the set of the first level of DC write power of 5.0 mW, the second level of DC write power of 4.8 mW, and the third level of DC write power of 4.6 mW is determined. The determined set of the first level of DC write power of 5.0 mW, the second level of DC write power of 4.8 mW, and the third level of DC write power of 4.6 mW is sent to the recording condition controller 14 as the determined DC write power information.

FIG. 11 is a schematic view illustrating an example of a method of forming a visible image using a plurality of levels of DC write power. Sections B and C are visible-image areas formed by respective different levels of DC write power. Thus, a visible image with different values of reflectivity at the sections B and C are formed. As described above, preparation of a plurality of levels of DC write power allow control of variation of reflectivity.

FIG. 12 illustrates an example of the special strategy information d20. Referring to FIG. 12, the special strategy information d20 is information that associates information (model number) of each disc with a corresponding special strategy. That is, for each disc information (model number), a corresponding optimum special strategy is stored in the special strategy information d20. For example, when the model number of the optical disc 1 is “DVD-◯◯◯”, the corresponding special strategy is STG 1, and the STG 1 is sent to the recording condition controller 14 as the determined special strategy information d20.

Note that the structure of the special strategy information d20 is not limited to the data structure illustrated in FIG. 12. As another example, FIG. 13 illustrates special strategy information d20 including a plurality of special strategies and a plurality of normal strategies. The special strategy information d20 illustrated in FIG. 13 is information that associates information (model number) of each disc with the set of a corresponding special strategy and a corresponding normal strategy. That is, for each disc information (model number), the set of a corresponding optimum special strategy and a corresponding optimum normal strategy is stored in the special strategy information d20. This aims at recording record data using a corresponding special strategy if a visible image has been formed in the optical disc 1, and at recording record data using a corresponding normal strategy if no visible images have been formed in the optical disc 1. As described above, the special strategy information d20 can be stored with consideration of cases where no visible images have been formed in the optical disc 1.

Note that the DC write-power information d10 illustrated in each of FIGS. 9 and 10 and the special strategy information d20 illustrated in each of FIGS. 11 and 12 use a model number for uniquely identifying the type of the optical disc 1, but can use another information for uniquely identifying the type of the optical disc 1.

A record-data capacitance checker 11 is adapted to check the capacity of the record data, and send, to the display position calculator 12, the checked capacity of the record data.

The display position calculator 12 is adapted to calculate, based on the recording start position of the record data sent from the disc information obtaining unit 8 and the capacity of the record data sent from the record-data capacity checker 11, a data recording area required to record the record data. The display position calculator 12 is also adapted to generate, based on display data for forming a visible image and the calculated data recording area, information of a display area on which DC writing is to be carried out, and send, to the control signal generator 13, the generated display-area information; the display-area information specifically includes a radial position and an angle.

The control signal generator 13 is operative to continuously grasp, based on the reference angle information sent from the driver 2 and the radial position information sent from the radial position detector 6, the location of the PUH. The control signal generator 13 is also operative to generate, based on the display-area information sent from the display position calculator 12 and the continuously grasped location of the PUH, DC recording control signals, and send, to the recording condition controller 14, the generated DC recording control signals.

The recording condition controller 14 is adapted to generate write signals (write pulses) according to each of the modes of: execution of the OPC, forming of a visible image (execution of the DC writing), and writing of record data. The recording condition controller 14 is also adapted to send, to the irradiating unit 3, the generated write pulses. Specifically, the recording condition controller 14 is adapted to send, in the mode of execution of the OPC, OPC irradiating signals generated based on OPC write power and the corresponding special strategy to the irradiating unit 3 in order to search for optimum write power. The recording condition controller 14 is also adapted to send, in the mode of forming of a visible image, DC write signals based on the DC recording control signals and DC write power information to the irradiating unit 3. The recording condition controller 14 is further adapted to send, in the mode of writing of record data, data write signals generated based on the optimum write power (special power) and the corresponding special strategy to the irradiating unit 3.

<Operations of the Information Recording Apparatus>

Next, operations of the information recording apparatus 100 according to this embodiment will be described hereinafter with reference to FIGS. 14 to 16. FIG. 14 is a flowchart illustrating operations of the data recording method of the information recording apparatus 100, FIG. 15 is a flowchart representing in detail a visible-image forming process in step S100 of FIG. 14, and FIG. 16 is a flowchart representing in detail a record-data recording process in step S200 of FIG. 14.

First, the operations of the data recording method of the information recording apparatus 100 will be described with reference to FIG. 14. The data recording method according to this embodiment is that the information recording apparatus 100 forms a visible image a data recording surface of the optical disc 1, and, thereafter, records record data in a formed visible-image area.

The information recording apparatus 100 carries out a visible-image forming process that performs the DC writing on a data recording surface of the optical disc 1 to form a preset character and/or an image thereon in step S100. Next, the information recording apparatus 100 performs a record-data recording process that records record data over the entire of the data recording surface including a visible-image area on which the preset character and/or image has been formed in step S200. Note that the visible-image forming process in step S100 and the record-data recording process in step S200 can be sequentially performed in a series of processes. Moreover, the visible-image forming process in step S100 can be performed first, and after a preset period has elapsed since the completion of the visible-image forming process, the record-data recording process in step S200 can be performed.

The visible-image forming process in step S100 will be fully described hereinafter with reference to FIG. 15.

The information recording apparatus 100 obtains the disc information of the optical disc 1 previously stored in the optical disc 1 mounted therein (step S110). For example, the disc information includes the manufacture, the model number, the type of the recording layer, the write strategy, and the like.

Next, the information recording apparatus 100 determines, based on the obtained disc information, a level of write power for the DC writing in step S120. Specifically, the information recording apparatus 100 retrieves one item of the plurality of items of DC write-power information d10 stored in the memory 10; the retrieved DC write-power information d10 corresponds to the obtained disc information (model number), thus determining the DC write power.

Next, the information recording apparatus 100 obtains the display-area information as position information associated with the area on which a visible image is to be formed in step S130.

Thereafter, the information recording apparatus 100 performs DC writing in accordance with the display-area information to thereby form a preset character and/or an image in step S140.

The record-data recording process in step S200 will be fully described hereinafter with reference to FIG. 16.

The information recording apparatus 100 obtains the disc information of the optical disc 1 previously stored in the optical disc 1 mounted therein (step S210). For example, the disc information includes the manufacture, the model number, the type of the recording layer, the write strategy, and the like. Note that, if the disc information obtained in step S110 of the visible-image forming process has been stored in the information recording apparatus 100, the disc information stored in the information recording apparatus 100 can be used without the need to obtain the optical disc 1 again.

Next, the information recording apparatus 100 determines, based on the obtained disc information, a special strategy in step S220. Specifically, the information recording apparatus 100 retrieves one of the plurality items of special strategy information d20 stored in the memory 10; the retrieved special strategy information d20 corresponds to the obtained disc information (model number), thus determining the special strategy.

Next, the information recording apparatus 100 carries out the OPC based on the determined special strategy to thereby find and determine an optimum level of write power in step S230; the optimum level of write power is optimum for writing the record data into the optical disc 1.

Thereafter, the information recording apparatus 100 performs writing of the record data based on the determined optimum level of write power in step S240.

As described above, according to this embodiment, even if a visible image area has been formed on a data recording surface of the optical disc 1, it is possible to write record data over the data recording surface including the visible-image area in a same recording condition, and maintain excellent the recording characteristics of an area on which the record data has been recorded. As a result, even if overwriting of record data is carried out on the visible-image area, it is possible to prevent deterioration of the recording characteristics. In addition, it is possible to write record data under simple control without regard to the boundaries between the visible-image area and unrecorded areas.

Note that, in this embodiment, the information recording apparatus 1 stores therein the DC write-power information and the special strategy information d20, but the DC write-power information d10 and the special strategy information d20 can be stored in the optical disc 1. In this case, because the optical disc 1 stores therein the DC write-power information d10 and the special strategy information d20, which are most suitable for its model number, the information recording apparatus 1 can obtain the DC write-power information d10 and the special strategy information d20 stored in the optical disc 1.

In addition, in this embodiment, performing DC writing forms a visible image, but the visible-image forming method is not limited to the DC writing. For example, in place of the DC writing for outputting a signal with constant write power as illustrated in (a) of FIG. 17, square-wave writing illustrated in (b) of FIG. 17 or sinusoidal-wave writing illustrated in (c) of FIG. 17 can be used. In the square-wave writing, controlling write power of a write signal illustrated in (a) of FIG. 18 can change the reflectivity of a visible-image area. In addition, as illustrated in (b) of FIG. 18, controlling the pulse widths of a write signal can change the reflectivity of a visible-image area. Another method of changing the reflectivity of the entire of a visible-image area can be used in place of the DC writing, the square-wave writing, or the sinusoidal-wave writing. As a write clock (cycle) of the square wave or the sinusoidal wave, a write clock for writing record data can be used in order to reduce the load of the recording apparatus.

In this embodiment, a same recording condition (the special recording condition) is used over the entire of an area on which record data is to be recorded, but different recording conditions can be selectively used.

FIG. 19 is a schematic view of a data recording method of such a case. For example, as illustrated in FIG. 19, if the DC writing is carried out for a section B so that the section B is established as a visible-image area, record data can be written on the section B under the special strategy in the special recording condition, and record data can be written on each of sections A and C under the normal recording condition. In this case, the information recording apparatus 100 needs to store in the memory 10 the special strategy information d20 illustrated in FIG. 13.

In the data recording method according to this embodiment, the information recording apparatus 100 forms a visible image on a data recording surface of the optical disc 1, and thereafter, writes record data on a formed visible-image area, but the information recording apparatus 100 can perfume them in the reverse order. Specifically, the information recording apparatus 100 can write record data on a data recording surface of the optical disc 1, and thereafter, form a visible image on an area on which the record data has been recorded.

FIG. 20 is a flowchart representing such operations of the data recording method. As illustrated in FIG. 20, the information recording apparatus 100 performs a record-data recording process that records record data over a data recording surface of the optical disc 1 in step S200. Next, the information recording apparatus 100 carries out a visible-image forming process that performs the DC writing on a part or the entire of the data recording surface on which record data has been recorded to form a preset character and/or an image thereon in step S100.

In this modification, because a level of the DC write power and a value of the special strategy are different from those used according to this embodiment, a level of the DC write power and a value of the special strategy need be stored.

For forming a visible image on an area on which record data has been recorded, the DC writing may affect on the recording characteristics of the area on which the record data has been recorded. Specifically, the DC writing may contribute to an imbalance between long marks and short marks in the area on which record data has been recorded. Thus, a special recording condition can be established with consideration of such an imbalance between long marks and short marks due to the DC writing. The inventors of this application has filed a patent application whose Publication is No. 2008-305485. This application discloses, after writing data on an area under a recording condition with the pulse width of a write signal for a preset mark, which is longer than an optimum pulse width for the preset mark, DC writing is carried out on the area on which the data has been recorded, making more excellent the recording characteristics of the data recorded area. Thus, using the disclosed principle can set the pulse width of a write signal for writing a shortest mark (3 T) in the special strategy to be longer than an optimum pulse width of a write signal for writing the shortest mark (3 T).

In order to carry out both the data recording method according to this embodiment and the data recording method according to this modification, the information recording apparatus 100 can be provided in the memory 10 with DC writing information d30 having two levels of DC write power (see FIG. 21), and with special strategy information d40 having two types of special strategies (see FIG. 22). In the DC writing information d30 illustrated in FIG. 21, first DC write power is used to write record data after the DC writing, and second DC write power is used to carry out the DC writing after writing of record data. In the special strategy information d40 illustrated in FIG. 22, a first special strategy is used to write record data after the DC writing, and a second special strategy is used to carry out the DC writing after writing of record data.

Note that running a program stored in the information recording apparatus 100 can carry out the operations of the information recording apparatus 100, and the program can be stored in a computer-readable storage medium, such as a ROM, a hard disk, a CD-ROM, a DVD-ROM, or the like, or can be distributed via a communication network.

The present invention is not limited to the embodiment set forth above, and the embodiment of the present invention can be deformed or modified within the scope of the present invention. Such deformations or modifications based on the embodiment can be within the technical range of the present invention.

### DESCRIPTION OF CHARACTERS

1 Optical disc
2 Driver
3 Irradiating unit
4 Receiving unit
5 Slider
6 Radial position detector
7 Reproducing characteristic measuring unit
8 Disk-information obtaining unit
9 Write-power searching unit
10 Memory
11 Record-data capacity checker
12 Display position calculator
13 Control signal generator
14 Recording condition controller
100 Information determining unit
d10, d30 DC write-power information
d20, d40 Special strategy information

1.-16. (canceled)

17. An information recording apparatus for irradiating a laser beam on an information recording surface of an information storage medium to record information, the information recording apparatus comprising:
a visible-image forming means that irradiates, as a first write signal, a laser beam on the information recording surface under a first recording condition to form at least one of a visible character and a visible image on the information recording surface; and
a record-data recording means that irradiates, as a second write signal, a laser beam on the information recording surface under a second recording condition to write record data on the information recording surface,
wherein a first area on which the laser beam is irradiated by the visible-image forming means under the first recording condition and a second area on which the laser beam is irradiated by the record-data recording means under the second recording condition have at least partly an area on which the laser beam under the first recording condition and the laser beam under the second recording condition are overlappedly irradiated, and the area on which the laser beam under the first recording condition and the laser beam under the second recording condition are overlappedly irradiated is an area from which the record data is to be reproduced by irradiating a laser beam on the area.

18. The information recording apparatus according to claim 17, wherein the second write signal is a pulse signal, and the second recording condition is to adjust a pulse width of the second write signal for writing a predetermined mark to be recorded relative to an optimum pulse width of the second write signal for writing the predetermined mark.

19. The information recording apparatus according to claim 18, wherein the predetermined mark is a shortest mark in a plurality of mark patterns for recording information on the information storage medium.

20. The information recording apparatus according to claim 19, wherein, if the laser beam under the second condition is irradiated after irradiation of the laser beam under the first recording condition, the second recording condition is to set the pulse width of the second write signal for writing the shortest mark to be shorter than the optimum pulse width of the second write signal for writing the shortest mark.

21. The information recording apparatus according to claim 20, wherein the second recording condition is to set the pulse width of the second write signal for writing the shortest mark to be substantially a half of a clock-cycle time corresponding to a length of the shortest mark.

22. The information recording apparatus according to claim 19, wherein, if the laser beam under the first recording condition is irradiated after irradiation of the laser beam under the second recording condition, the second recording condition is to set the pulse width of the second write signal for writing the shortest mark to be longer than the optimum pulse width of the second write signal for writing the shortest mark.

23. The information recording apparatus according to claim 17, wherein the first recording condition is comprised of a plurality of recording conditions respectively having different variations in reflectivity of the information recording surface on which a laser beam is irradiated.

24. The information recording apparatus according to claim 17, wherein the first recording condition is DC writing with a substantially constant write power.

25. The information recording apparatus according to claim 24, wherein the write power of the DC writing is determined based on variations in reflectivity of the first area.

26. The information recording apparatus according to claim 17, wherein the first recording condition is that a waveform of the first write signal for forming the at least one of the visible character and the visible picture is a square wave.

27. The information recording apparatus according to claim 17, wherein the first recording condition is that a waveform of a write signal for forming the at least one of the visible character and the visible picture is a sinusoidal wave.

28. The information recording apparatus according to claim 17,
wherein the first recording condition is a plurality of first recording conditions provided respectively for a plurality of types of information recording media including the information recording medium, and the second recording condition is a plurality of second recording conditions provided respectively for the plurality of types of information recording media, further comprising an information storage means that stores therein recording condition information that associates each type of the information recording media with a corresponding one of the plurality of first recording conditions and a corresponding one of the plurality of second recording conditions,
the visible image forming means obtaining, from the information storage means, a corresponding one of the plurality of first recording conditions associated with the type of the information recording medium, the record-data recording means obtaining, from the information storage means, a corresponding one of the plurality of first recording conditions associated with the type of the information recording medium.

29. The information recording apparatus according to claim 28, wherein a plurality of third recording conditions are provided respectively for the plurality of types of information recording media, and the recording condition information associates each type of the information recording media with: a corresponding one of the plurality of first recording conditions, a corresponding one of the plurality of second recording conditions, and a corresponding one of the plurality of third recording conditions, each of the plurality of third conditions being optimum for recording record data if at least one of the visible character and the visible image is not formed in the information recording surface of a corresponding type of the information recording media.

30. An information recording method of irradiating a laser beam on an information recording surface of an information storage medium to record information, the information recording method comprising:
a visible-image forming step that irradiates, as a first write signal, a laser beam on a first area of the information recording surface under a first recording condition to form at least one of a visible character and a visible picture on the first area; and
a record-data recording step that irradiates, after execution of the visible-image forming step, a laser beam, as a second write signal, on a second area of the information recording surface under a second recording condition to write record data on the second area, the second area including the first area,
wherein the second recording condition is to set a pulse width of the second write signal for writing a predetermined mark to be recorded to be shorter than an optimum pulse width of the second write signal for writing the predetermined mark.

31. An information recording method of irradiating a laser beam on an information recording surface of an information storage medium to record information, the information recording method comprising:
a record-data recording step that irradiates, as a third write signal, a laser beam on a third area of the information recording surface under a third recording condition to write record data on the third area;
a visible-image forming step that irradiates, after execution of the record-data recording step, a laser beam, as a fourth write signal, on at least part of the third area under a fourth recording condition to change a reflectivity of the information recording surface, thus forming at least one of a visible character and a visible picture on the at least part of the third area,
wherein the third recording condition is to set a pulse width of the third write signal for writing a predetermined mark to be recorded to be longer than an optimum pulse width of the third write signal for writing the predetermined mark.

32. A computer program that functions a computer as each means of the information recording apparatus recited in claim 17.

33. The information recording apparatus according to claim 17, wherein the area on which the laser beams are overlappedly irradiated is located outside of a read-in area, and is a data area on which the record data is to be recorded.

34. The information recording apparatus according to claim 17, wherein, after the visible-image forming means has irradiated the laser beam under the first recording condition, the record-data recording means irradiates the laser beam under the second recording condition.
